(19) United States
(12) Patent Application Publication
(10) Pub. No.: US 2018/0144862 A1
(43) Pub. Date: May 24, 2018

(54) DEVICE FOR ENABLING A NON-INTEGER NUMBER OF WINDINGS TO BE PROVIDED ON AN INDUCTOR

(71) Applicant: PowerbyProxi, Auckland (NZ)

(72) Inventors: Natasha Lillian Kristoffersen-Tuck, Auckland (NZ); Michael Victor Paauwe, Auckland (NZ)

(21) Appl. No.: 15/817,030

(22) Filed: Nov. 17, 2017

(30) Foreign Application Priority Data
Nov. 18, 2016 (CN) 201621253662

(51) Int. Cl. H01F 41/06; H01F 38/14; H01F 27/28; H01F 27/24

(52) U.S. Cl. CPC H01F 41/06; H01F 27/24; H01F 27/2823; H01F 38/14

(57) ABSTRACT

The invention provides a device for enabling a non-integer number of windings to be provided on an inductor. The device comprises a generally planar member adapted to be positioned adjacent to a magnetic or magnetisable core of an inductor. The member has a wire guide, preferably in the form of a slot, said wire guide comprising a first wire guide portion extending from a peripheral edge of the member towards a central axis thereof, but not reaching said central axis, and including a second wire guide portion which extends from said first wire guide portion to at least partially extend around said central axis. The wire guide enables terminal ends of the inductor coil wire to be brought together to exit the inductor and yet enable a non-integer number of windings to be wound on the magnetic or magnetisable core of the inductor.

This application claims priority to Chinese patent application No. 201621253662, filed on Nov. 18, 2016, which is hereby incorporated by reference herein in its entirety.

### FIELD OF THE INVENTION

The invention relates to a device for enabling a non-integer number of windings to be formed on an inductor.

### BACKGROUND OF THE INVENTION

An inductor, also called a coil or a reactor, is typically a passive two-terminal electrical component which resists changes in electric current passing through it. It consists of a conductor such as a wire usually wound into a number or turns, comprising a coil, around a magnetic or magnetisable core such as a ferrite core. Energy is stored in a magnetic field in the coil as long as current flows through the wire.

In wireless or induction (IPT) power transfer systems, by way of example, the wireless power transfer devices include a magnetic coil as part of the power transmitter (Tx) and/or receiver (Rx) apparatus(es). The Tx/Rx coils form part of a resonant circuit. It is required that the Tx/Rx coils have a low predetermined value of coil inductance falling within a tight tolerance of typically ±1% of the predetermined required inductance value.

Typically inductors are tuned by adding or removing complete turns, i.e. windings. But, wireless power transfer device Tx/Rx coils typically have fewer than 20 turns and as few as 16 turns. Consequently, each turn represents between about 5% and 6% of the total coil inductance value so it is not normally possible to adjust the inductance value to get within the desired ±1% tolerance level by adjusting the number of complete turns, i.e. adjusting the integer number of turns.

One method to adjust the inductance value of a coil comprises manually adding or removing a fraction of a turn. This may be done by adjusting a position at which an outer end of the conductor wire leaves the coil windings before or after completion of a turn.

FIGS. 1A and 1B show a conductor wire 10 wound as a coil 12 around a ferrite core member 14 with the inner end 10a and the outer end 10b of the wire 10 shown in solid line extending together away from the core member 14. The ferrite core member 14 comprises a circular disk with a central projection 16 around which the wire 10 is wound. The inner end 10a of the wire 10 starts close to the central core projection 16 and the outer end 10b of the wire 10 can be seen leaving the coil 12 at a position aligned with the position of the inner end 10a. Consequently, the wire 10 shown in solid line is wound an integer number of times around the core projection 16, i.e. the wire 10 makes a complete number of turns around the core projection 16. The ferrite core member 14 has a slot 18 for receiving the inner end 10a of the wire 10. However, the slot 18 is intended to only support integer numbers of turns of the wire 10, i.e. the inner end 10a of the wire 10 received in the slot 18 is aligned with an outer end 10b of the wire 10 when said outer end 10b reaches the slot 18 to form a complete turn. But, as discussed, changing the number of complete turns is much too coarse a method to adjust the coil inductance to within ±1% of the predetermined required inductance value.

Referring again to FIGS. 1A and 1B, shown by way of contrast in dashed line is the outer end 10b of the wire 10 leaving the coil windings before the position of the slot 18 such that a dashed line path of the wire 10 extends across a back side of the core member 14 opposite to the side on which the coil windings are formed around the projection 16. The arrangement is such that the outer end 10b of the wire 10 can then exit the inductor housing (not shown) alongside the inner end 10a of the wire 10 at the slot 18 as before. However, the outer end 10b of the wire follows a path across the back side of the ferrite core member 14 towards the position of the inner end 10b of the wire 10. In this way, it is possible to provide a non-integer number of turns of the wire 10 on the ferrite core member 14 whilst arranging the inner end 10a and the outer end 10b of the wire 10 to still exit the inductor housing together, but there are several disadvantages with this method, not least the fact that the outer end 10b of the wire 10 along the dashed line path is easily dislodged thereby compromising the inductance value of the coil 12.

### OBJECTS OF THE INVENTION

An object of the present invention is to provide a device for enabling a non-integer number of windings to be provided on an inductor.

Another object of the present invention is to mitigate or obviate to some degree one or more problems associated with known methods of providing a non-integer number of windings on an inductor or coil.

### SUMMARY OF THE INVENTION

To allow for a non-integer number of turns, a device comprising a generally planar member, preferably in the form of a trimming disk, is used on the back of the magnetic or magnetisable core member to guide an outer end of the wire back to the inner end of the wire. This allows the outer end of the wire to emerge at any rotational position relative to the core windings without having to complete a full number of turns. Changing the position within a turn at which the outer end of the wire may leave the coil windings is sufficient to finely adjust the inductance of the coil to achieve the required inductance level within the required ±1% tolerance level. Although superficially the wire still completes an integer number of turns, the final part of the last turn occurs behind the core member in the device of the invention where its contribution to the total coil inductance is considerably reduced and possibly even negligible.

Therefore, in one main aspect, the invention provides a device for enabling a non-integer number of windings to be provided on an inductor, said device comprising a member adapted to be positioned adjacent to a magnetic or magnetisable core of an inductor, said member having a wire guide, said wire guide comprising a first wire guide portion extending from a peripheral edge of the member towards a central axis thereof, but not reaching said central axis, and including a second wire guide portion which extends from said first wire guide portion to at least partially extend around said central axis. Also provided is a coil module for an induction power transfer (IPT) receiver, transmitter or transceiver comprising: the trimming disk member of the invention mounted adjacent to an inductor core member of the coil module, wherein an inductor coil is wound on the core member with an inner end and an outer end of the wire forming the coil received in a wire guide of the trimming disk member.

### BRIEF DESCRIPTION OF THE DRAWINGS

The foregoing and further features of the present invention will be apparent from the following description of preferred embodiments which are provided by way of example only in connection with the accompanying figure, of which:

FIG. 1A is a plan view of a ferrite core member of an inductor;

FIG. 1B is a side view of the ferrite core member of FIG. 1A;

FIG. 2 is a plan view of one embodiment of a trimming disk member according to the invention;

FIG. 3 is a plan view of another embodiment of a trimming disk member according to the invention;

FIG. 4 is another view of the trimming disk member of FIG. 3;

FIGS. 5A and 5B are plans views of the trimming disk member of FIG. 3 in use;

FIG. 6 is a view of components including the trimming disk member of FIG. 3 forming a wireless power device according to the invention; and

FIG. 7 is a view of the inner and outer ends of the conductor wire brought together by the trimming disk device of FIG. 3.

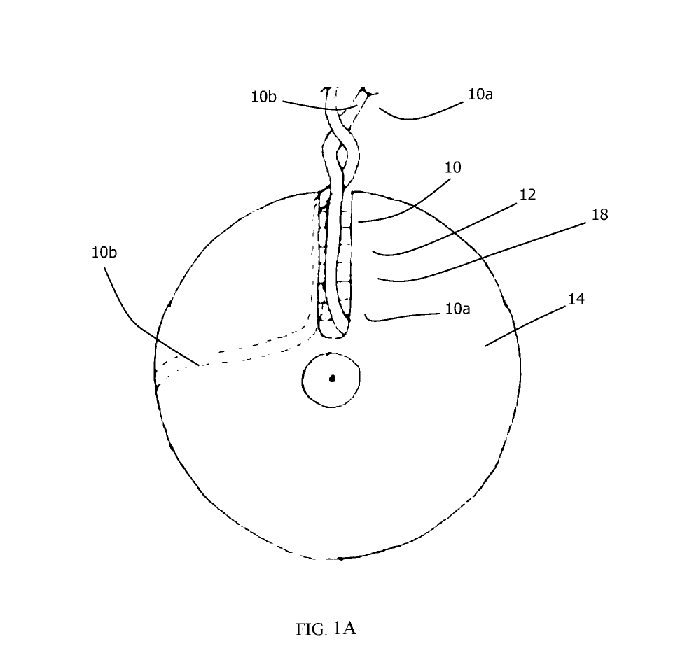

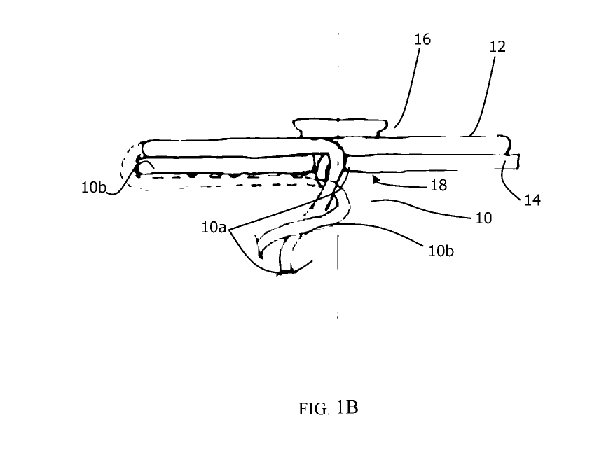

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

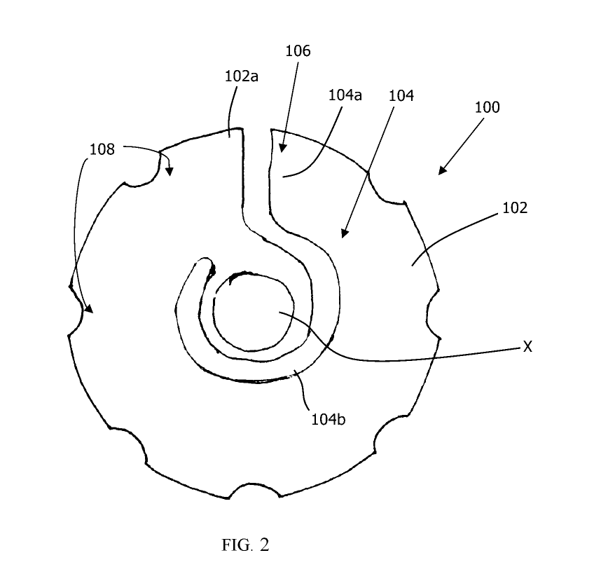

Referring to FIG. 2, shown is a device 100 for enabling a non-integer number of windings to be provided on an inductor. The device 100 comprises a member 102, preferably in the form of a trimming disk, which is adapted to be used on the back of a magnetic or magnetisable core member of an inductor. The member 102 is adapted to guide an outer end of an inductor conductor wire back to a position of an inner end of the wire when the outer end of the wire exits the inductor coil at any point within a turn, i.e. a winding, without the requirement of having the wire complete a full turn. This allows the outer end of the wire to emerge at different rotational positions with respect to a slot in the inductor core member where such slot is present or, in any event, at any position relative to the core windings.

The trimming disk member 102 comprises a wire guide 104. The wire guide 104 comprises a first wire guide portion 104a extending from a peripheral edge 102a of the member 102 towards a central axis X thereof, but not reaching said central axis X. The wire guide 104 further comprises a second wire guide portion 104b which extends from said first wire guide portion 104a to at least partially extend around said central axis X. The first wire guide portion 104a may extend directly inwardly from said peripheral edge 102a of the member 102 towards said central axis X and the second wire guide portion 104b may extend from said first wire guide portion 104a in a curve at least partially around said central axis X. Preferably, the second wire guide portion 104b extends from an inner end of the first wire guide portion 104a. Preferably, the second wire guide portion 104b extends 180 degrees or more around said central axis X of the member 102.

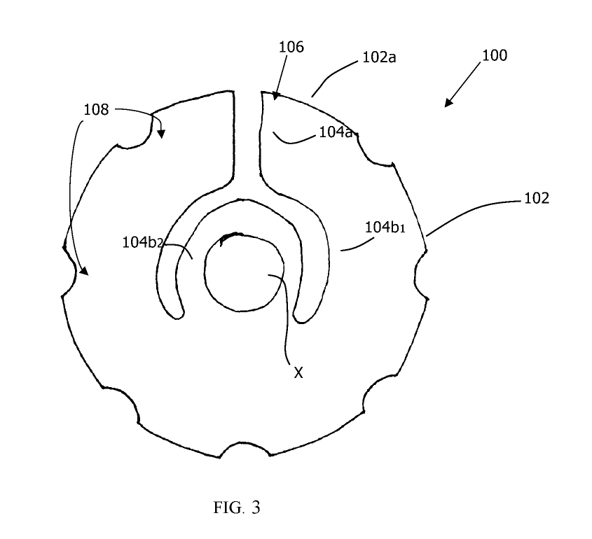

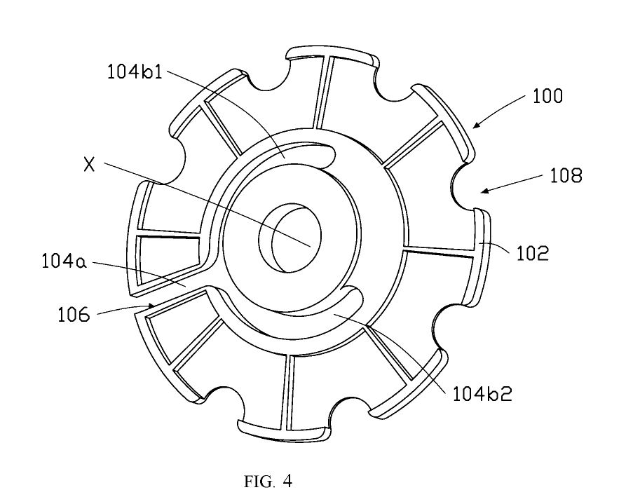

In another embodiment as shown in FIGS. 3 and 4, the second wire guide portion 104b comprises primary and secondary wire guide portions 104b1 and 104b2 which each extend from said first wire guide portion 104a in a curve at least partially around said central axis X of the member 102, but in opposing directions. Preferably, said primary and secondary wire guide portions 104b1, 104b2 between them extend 180 degrees or more around said central axis X of the member 102.

Preferably, in all embodiments, the member 102 is formed of a non-magnetic material. Preferably, in all embodiments, the wire guide 104 comprises a slot 106 in the member 102. Preferably, in all embodiments, the member 102 is generally planar. Preferably, in all embodiments, the member 102 is disk-shaped. Preferably, in all embodiments, the member 102 has a plurality of indents or recesses 108 around its peripheral edge 102a.

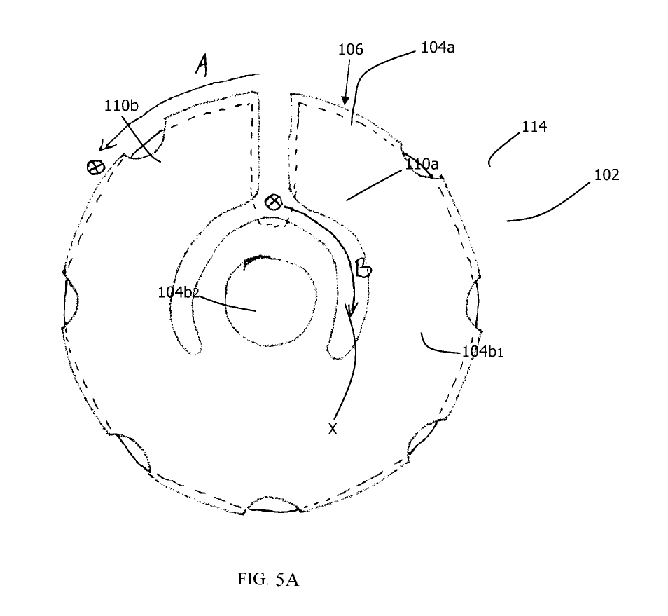

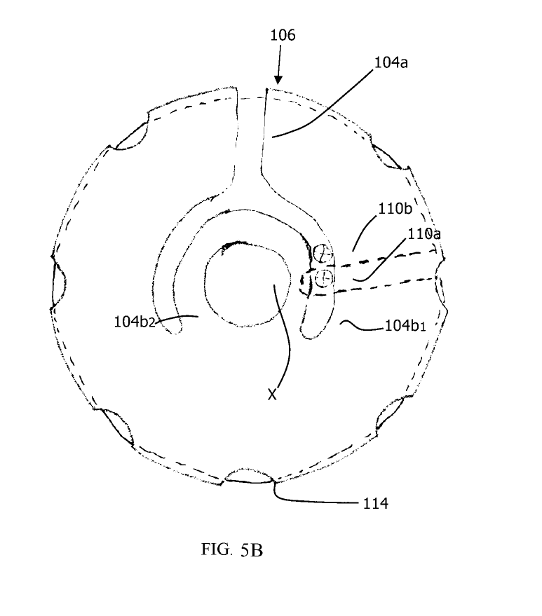

Referring to FIGS. 5A and 5B, shown is a coil module for an induction power transfer (IPT) receiver, transmitter or transceiver comprising the trimming disk member 102 according to any embodiment of the invention mounted adjacent to the inductor core member 114. The inductor coil is wound on the core member 114 as hereinbefore described with the inner end and the outer end of the wire forming the coil received in the wire guide 104 of the trimming disk member 102. In the embodiment of the IPT module shown in FIGS. 5A and 5B, the wire guide 104, including its primary and secondary wire guide portions 104b1 and 104b2 which between them comprise a curved part of slot 106 in the trimming disk member 102, first receives an inner end 110a of the conductor wire. The curved part of the slot 106 is preferably semi-circular. The curved part of the slot 106 allows the trimming disk member 102 to be rotated in the direction of arrow A relative to the inductor coil being wound on the inductor core member 114. Consequently, the inner end 110a of the wire, the inductor core member 114 and the coil being formed on the coil member 114 each move together in the direction of arrow B relative to the trimming disk member 102. The relative movement is such that the trimming disk member 102 can be rotated to a position where the first wire guide portion 104a of the slot 106 lines up radially with the outer end 110b of the wire 110 coming from the coil. The outer end 110b of the wire 110 then runs along the radial part 104a of the slot 106, and, if necessary, around the semi-circular part of the slot 106 towards the inner end 110a of the wire. This enables a non-integer number of turns to be formed on the inductor core member 114 whilst providing a guideway for bringing the inner end 110a and the outer end 110b of the conductor wire 110 together prior to said ends 110a, 110b exiting a housing of the inductor.

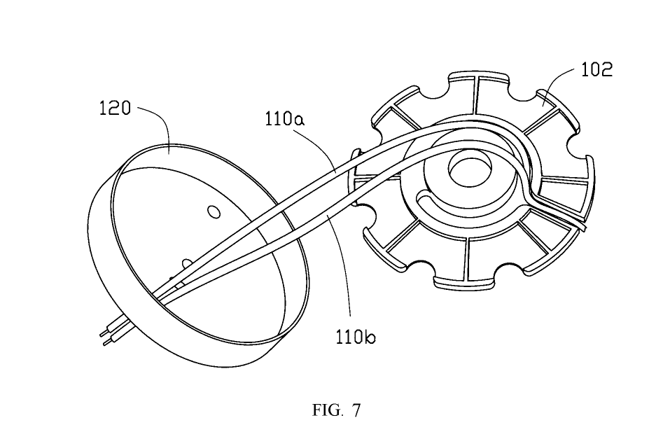

Having both ends 110a, 110b of the coil exit the housing 120 close together, preferably intertwined or twisted together, also reduces inductance variation due to the unconstrained path of the wires once they pass outside the housing as shown in FIG. 7.

In some embodiments of the trimming disk member 102, a full circular wire guide 104 in the form of a full circular slot could be used to allow for a greater degree of trimming disk member rotation, but this would require a two-part disk.

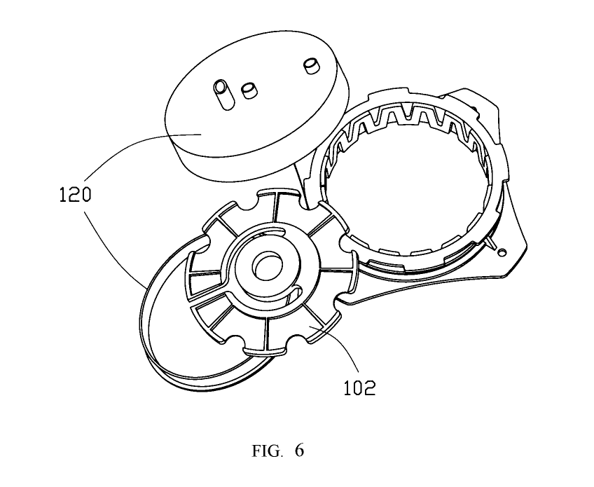

Once the number of turns is trimmed using the trimming disk member 102 as disclosed, the inductor coil and core member 114 are enclosed in the coil housing 120 of FIGS. 6 and 7 with the two ends 110a, 110b of the conductor wire exiting the housing 120 via a suitable orifice.

The housing assembly may then be sealed by injection of a polymer encapsulant material. The encapsulant material serves to immobilise the internal wires and the core member. This prevents any change to the inductance that may otherwise occur due to movement of the wires and/or the core member.

The encapsulant material may also contain filler materials to enhance its thermal conductivity. This helps to manage the internal temperature rise as a result of ohmic losses during operation.

The encapsulant material mixture is introduced through a central small circular orifice in the housing 120 and allowed to flow radially around the coil and core. Another small circular orifice comprises a vent to allow the escape of air as it is displaced by the encapsulant material mixture. The indents or recesses 108 on the trimming disk member 102 assist movement of the encapsulant material mixture throughout the housing to fully encapsulate the trimming disk member and inductor core with coil.

The present description illustrates the principles of the present invention. It will thus be appreciated that those skilled in the art will be able to devise various arrangements that, although not explicitly described or shown herein, embody the principles of the invention and are included within its spirit and scope.

1. A device for enabling a non-integer number of windings to be provided on an inductor, said device comprising:
a member adapted to be positioned adjacent to a magnetic or magnetisable core of an inductor, said member having a wire guide, said wire guide comprising a first wire guide portion extending from a peripheral edge of the member towards a central axis thereof, but not reaching said central axis, and including a second wire guide portion which extends from said first wire guide portion to at least partially extend around said central axis.

2. The device of claim 1, wherein the first wire guide portion extends directly inwardly from said peripheral edge of the member towards said central axis and the second wire guide portion extends from said first wire guide portion in a curve at least partially around said central axis of the member.

3. The device of claim 2, wherein the second wire guide portion extends 180 degrees or more around said central axis of the member.

4. The device of claim 1, wherein the first wire guide portion extends directly inwardly from said peripheral edge of the member towards said central axis and the second wire guide portion comprises primary and secondary wire guide portions which each extend from said first wire guide portion in a curve at least partially around said central axis of the member, but in opposing directions.

5. The device of claim 4, wherein the primary and secondary wire guide portions between them extend 180 degrees or more around said central axis of the member.

6. The device of any one of claims 1 to 5, wherein the member is formed of a non-magnetic material.

7. The device of any one of claims 1 to 5, wherein the wire guide comprises a slot in the member.

8. The device of any one of claims 1 to 5, wherein the member is one or more of generally planar and disk-shaped.

9. The device of any one of claims 1 to 5, wherein the member has a plurality of indents or recesses in its peripheral edge.

10. A coil module including the device of any one of claims 1 to 5, wherein the coil module is suitable for an induction power transfer (IPT) receiver, transmitter or transceiver and the device is mounted adjacent to an inductor core member of the coil module, wherein an inductor coil is wound on the core member with an inner end and an outer end of the wire forming the coil received in a wire guide of the device.
